(19) United States
(12) Patent Application Publication
(10) Pub. No.: US 2008/0106800 A1
(43) Pub. Date: May 8, 2008

(54) Zoom lens system

(76) Inventor: Jeong-Kil Shin, Suwon-si (KR)

Correspondence Address: CHA & REITER, LLC, 210 ROUTE 4 EAST STE 103, PARAMUS, NJ, 07652, US

(21) Appl. No.: 11/821,272

(22) Filed: Jun. 22, 2007

(30) Foreign Application Priority Data
Jun. 23, 2006 (KR) 2006-56943

(51) Int. Cl. G02B 15/14

(52) U.S. Cl. 359/689

(57) ABSTRACT

A zoom lens system includes a first lens group having a negative refracting power and disposed on a image surface, a second lens group located closer to the image surface than the first lens group and having a positive refracting power, and a third lens group located closer to the image surface than the second lens group and having the negative refracting power, wherein when the zoom lens system zooms from a wide angle end to a telephoto end, both a distance between the first and second lens groups and a distance between the first and third lens groups are reduced.

### CLAIM OF PRIORITY

This application claims priority under 35 U.S.C. §119 to an application entitled “Zoom Lens System,” filed in the Korean Intellectual Property Office on Jun. 23, 2006 and assigned Serial No. 2006-56943, the contents of which are incorporated herein by reference.

### BACKGROUND OF THE INVENTION

1. Field of the Invention

The present invention relates generally to a zoom lens system, and in particular, to a micro zoom lens system suitable for use in a micro video camera or digital camera.

2. Description of the Related Art

Recently, digital and video cameras using an image pickup device, such as a Charge-Coupled Device (CCD) or a Complementary Metal-Oxide Semiconductor (CMOS), have been readily available on the market. Along this tendency, zoom lens systems embodied in these cameras tend to be compact, light-weighted, and low-cost.

A zoom lens system typically includes a first lens group having a negative refracting power and a second lens group located closer to the image surface than the first lens group and having a positive refracting power, wherein zooming is accomplished by means of movement of the second lens group and focus shift due to the zooming is compensated for by means of movement of the first lens group. However, as the zoom lens system requires its full length to change considerably while the first and second lens groups are moving along an optical axis, a configuration of a lens barrel is complex.

Japan Patent Publication No. H8-248318 discloses a zoom lens system having an optical axis bent by an orthogonal prism and having a 3:1 zoom ratio. A zoom ratio indicates a ratio of a total focal length fw at a wide angle position (wide angle end) to a total focal length ft at a telephoto position (telephoto end), i.e., fw/ft. The zoom lens system has the maximum focal length at the telephoto end and the minimum focal length at the wide angle end.

However, although the zoom lens system has an advantage in that a configuration of a lens barrel can be simplified by reducing its full length using the orthogonal prism, it is difficult to further reduce the full length since the position of a stop is fixed. Also, it is difficult to miniaturize the zoom lens system since an external diameter of a lens located in the front end of an object side is very large, As described above, there is a need for a micro zoom lens system that is suitable in a micro video camera or digital camera capable of providing a high-performance.

### SUMMARY OF THE INVENTION

The present invention substantially solves at least the above problems and/or disadvantages and provides additional advantages, by providing a high-performance micro zoom lens system suitable for a micro video camera or digital camera.

According to one aspect of the present invention, there is provided a zoom lens system comprising: a first lens group having a negative refracting power; a second lens group located closer to the image surface than the first lens group and having a positive refracting power; and a third lens group located closer to the image surface than the second lens group and having a negative refracting power, wherein when the zoom lens system zooms from a wide angle end to a telephoto end, both a distance between the first and second lens groups and a distance between the first and third lens groups are reduced.

According to another aspect of the present invention, there is provided a zoom lens system comprising: a first lens group having a negative refracting power and having a reflective surface for bending an optical axis; a second lens group located closer to the image surface than the first lens group and having a positive refracting power; and a third lens group located closer to the image surface than the second lens group and having the negative refracting power.

### BRIEF DESCRIPTION OF THE DRAWINGS

The above features and advantages of the present invention will become more apparent from the following detailed description when taken in conjunction with the accompanying drawing in which:

FIGS. 1 to 3 are configuration diagrams of a zoom lens system according to an embodiment of the present invention;

FIG. 4 illustrates aberration curves of the zoom lens system illustrated in FIG. 1;

FIG. 5 illustrates aberration curves of the zoom lens system illustrated in FIG. 2; and

FIG. 6 illustrates aberration curves of the zoom lens system illustrated in FIG. 3.

### DETAILED DESCRIPTION OF THE EMBODIMENT

Now, embodiments of the present invention will be described herein below with reference to the accompanying drawings. For the purposes of clarity and simplicity, well-known functions or constructions are not described in detail as they would obscure the invention in unnecessary detail.

A zoom lens system according to an embodiment of the present invention includes a first lens group having a negative refracting power, a second lens group located closer to the image surface than the first lens group and having a positive refracting power, and a third lens group located closer to the image surface than the second lens group and having the negative refracting power.

In operation, when the zoom lens system zooms from a wide angle end to a telephoto end, the first lens group is fixed, and the second and third lens groups move toward the first lens group along an optical axis. Then, a distance between the first and second lens groups is gradually reduced, and a distance between the second and third lens groups is gradually reduced and thereafter gradually increased. Here, the distance indicates a distance along the optical axis, i.e., a distance on the optical axis.

According to the teachings of the present invention, focus drift due to the zooming in the zoom lens system is compensated for by means of movement of the image surface. The zoom lens system can secure an enough light amount with a wide view angle in the wide angle end by sequentially arranging the first lens group having the negative refracting power and the second lens group having the positive refracting power from an object side to the image surface.

Preferably, the first lens group has a reflective surface for bending the optical axis. The reflective surface may be embodied in a prism or a mirror. By the first lens group bending the optical axis, a full length of the zoom lens system can be reduced, a distance between the reflective surface and the image surface, instead of a distance between a front end of the first lens group and the image surface.

Preferably, the second lens group includes a stop in a front end thereof, and the stop may be an optical surface located in an object-side front end portion of the second lens group or be additionally disposed ahead the object-side front end portion of the second lens group. The stop included in the second lens group allows a diameter of a lens located at an object-side front end portion of the first lens group. The optical surface includes a lens surface, the reflective surface, the surface of the prism, and the surface of an Infrared (IR) cut-filter and also includes an arbitrary reflective surface and a refractive surface represented by the radius of curvature and changing the path of light. Here, a plane can be expressed in that it has an infinite radius of curvature.

Preferably, the first lens group includes at least two lenses having the negative refracting power, a reflective surface, and at least one lens having the positive refracting power. More preferably, the first lens group includes a first lens having the negative refracting power, an orthogonal prism, a second lens having the negative refracting power, and a third lens having the positive refracting power. The first lens, the orthogonal prism, the second lens, and the third lens are sequentially arranged from the object side to the image surface. The first and second lenses having the negative refracting power are made of a material having a low Abbe number, which is a measure of dispersion, and the third lens having the positive refracting power is made of a material having a high Abbe number. Under the conditions, a chromatic difference of magnification of the first lens group can be compensated for.

Preferably, the second lens group includes at least two lenses having the positive refracting power and at least one lens having the negative refracting power. More preferably, the second lens group includes a first lens having the positive refracting power, a second lens having the negative refracting power, and a third lens having the positive refracting power. The first lens, the second lens, and the third lens are sequentially arranged from the object side to the image surface. The first and third lenses having the positive refracting power are made of a material having a low Abbe number, and the second lens having the negative refracting power is made of a material having a high Abbe number. Under the conditions, a chromatic difference of magnification of the second lens group can be compensated for.

Preferably, the third lens group includes at least one lens having the positive refracting power and at least one lens having the negative refracting power. More preferably, the third lens group includes a first lens having the positive refracting power and a second lens having the negative refracting power. The first lens and the second lens are sequentially arranged from the object side to the image surface.

Preferably, in order to minimize distortion aberration and have imaging performance suitable for high resolution, each of the first through third lens group can have at least one aspherical lens. In order to reduce costs, the aspherical lens can be made of a plastic material.

Preferably, the zoom lens system satisfies Formula 1.

$$4.9 < \frac{TTL}{fw} < 6 \qquad ( 1 )$$

Here, TTL denotes the distance between the reflective surface and the image surface, and fw denotes a focal length of the zoom lens system in the wide angle end.

Formula 1 is related to the full length of the zoom lens system, wherein if TTL/fw is equal to or greater than 6, the full length of the zoom lens system is too long to miniaturize the zoom lens system, and if TTL/fw is equal to or less than 4.9, optical performance of the zoom lens system is decreased.

Preferably, the zoom lens system satisfies Formula 2.

$$0.7 < \frac{fw}{f 2} < 0.77 \qquad ( 2 )$$

Here, f2 denotes a focal length of the second lens group.

Formula 2 is related to the distribution of an optical power of the zoom lens system, wherein if fw/f2 is equal to or greater than 0.77, the full length of the zoom lens system is too long to miniaturize the zoom lens system, and if fw/f2 is equal to or less than 0.7, the optical performance of the zoom lens system is decreased.

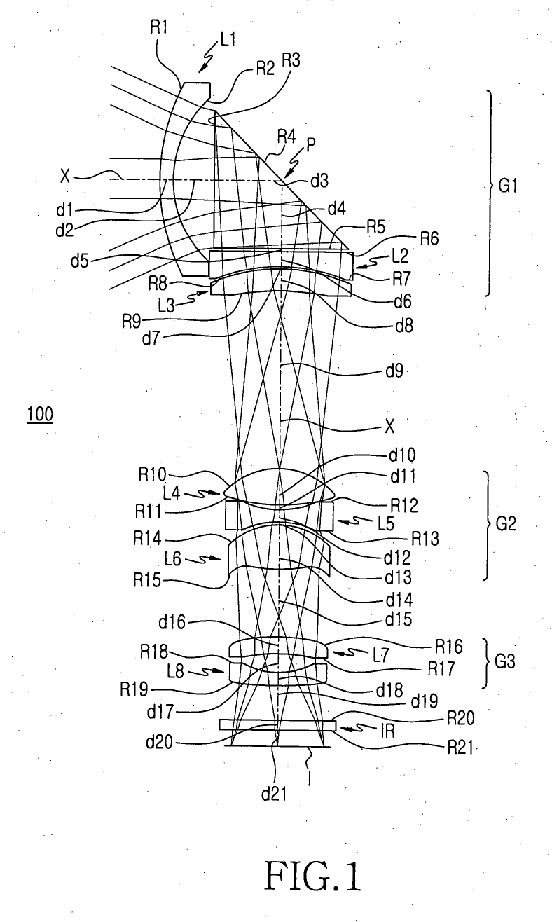

FIGS. 1 to 3 illustrate the configuration diagrams of a zoom lens system 100 according to an embodiment of the present invention. FIGS. 1 to 3 respectively depict states of a wide angle end, an intermediate end, and a telephoto end according to zooming of the zoom lens system 100. FIGS. 1 to 3 depict tracing of three light beam groups incident to the zoom lens system 100 and having different angles on an optical axis X. It should be noted that FIGS. 1-3 are for illustrative purposes, thus other arrangements known to artisians in compliance with the teachings of the present invention are also applicable.

The zoom lens system 100 according to the present invention may include first to third lens groups G1, G2, and G3 and an Infrared (IR) cut filter IR. The first lens group G1 and the IR-cut filter IR are fixed, and the second and third lens groups G2 and G3 are selectively movable along the optical axis X.

The first lens group G1 has a negative refracting power and may include a first lens L1, an orthogonal prism P, a second lens L2, and a third lens L3 that are sequentially arranged from an object side to the image surface I. The first lens L1 has a convex first optical surface R1 and a concave second optical surface R2, and the spherical surfaces on its both ends is convex and the other is concave, respectively. The orthogonal prism P bends the optical axis X at a right angle and includes third to fifth optical surfaces R3, R4, and R5 that are sequentially arranged from the object side to the image surface I, wherein each of the third to fifth optical surfaces R3, R4, and R5 is a plane, and the fourth optical surface R4 is a reflective surface for reflecting incident light.

In the zoom lens system 100, all optical surfaces except the fourth optical surface R4 are refractive surfaces for transmitting incident light. The third and fifth optical surfaces R3 and R5 are perpendicular to the optical axis X, and the fourth optical surface R4 is at a 45° angle to the optical axis X. The second lens L2 has a concave sixth optical surface R6 and a concave seventh optical surface R7 that are sequentially arranged from the object side to the image surface I. As shown, the second lens L2 has concave aspherical surfaces on its both sides and has the negative refracting power. The third lens L3 has a convex eighth optical surface R8 and a concave ninth optical surface R9 that are sequentially arranged from the object side to the image surface I. As shown, the third lens L3 has spherical surfaces on its both sides-one side is convex and the other is concave, and has the positive refracting power.

The second lens group G2 includes fourth to sixth lenses L4, L5, and L6 having a positive refracting power and sequentially arranged from the object side to the image surface I. The fourth lens L4 has a convex tenth optical surface R10 and a convex eleventh optical surface R11 that are sequentially arranged from the object side to the image surface I. The fourth lens L4 has convex aspherical surfaces on its both sides and has the positive refracting power, wherein the tenth optical surface R10 of the fourth lens L4 acts as a stop. The fifth lens L5 has a concave twelfth optical surface R12 and a concave thirteenth optical surface RI 3 that are sequentially arranged from the object side to the image surface I. The fifth lens 15 has concave spherical surfaces on its both sides and has the negative refracting power. The sixth lens L6 has a convex fourteenth optical surface R14 and a concave fifteenth optical surface R15 that are sequentially arranged from the object side to the image surface I. The aspherical surfaces of the sixth lens L6 on its both sides-one side is convex and the other is concave, respectively, and has the positive refracting power.

The third lens group G3 includes seventh and eighth lenses L7 and L8 having a negative refracting power and sequentially arranged from the object side to the image surface I. The seventh lens L7 has a convex sixteenth optical surface R16 and a concave seventeenth optical surface R17 that are sequentially arranged from the object side to the image surface I. The seventh lens L7 has aspherical surfaces on its both ends is convex and the other is concave, respectively and has a positive refracting power. The eighth lens L8 has a concave eighteenth optical surface R18 and a convex nineteenth optical surface R19 that are sequentially arranged from the object side to the image surface I. The spherical surfaces of the eighth lens L8 on its both sides is concave and the other is convex, respectively, and has the negative refracting power.

The IR-cut filter IR has a flat twentieth optical surface R20 and a flat twenty-first optical surface R21 that are sequentially arranged from the object side to the image surface I. The IR-cut filter IR has flat surfaces on its both sides and has an IR filter function.

When the zoom lens system 100 zooms from the wide angle end to the telephoto end, the first lens group G1 is fixed, and the second and third lens groups G2 and G3 move toward the first lens group G1 along the optical axis X. In this case, a distance between the first and second lens groups G1 and G2 is gradually reduced, and a distance between the second and third lens groups G2 and G3 is gradually reduced and thereafter gradually increased.

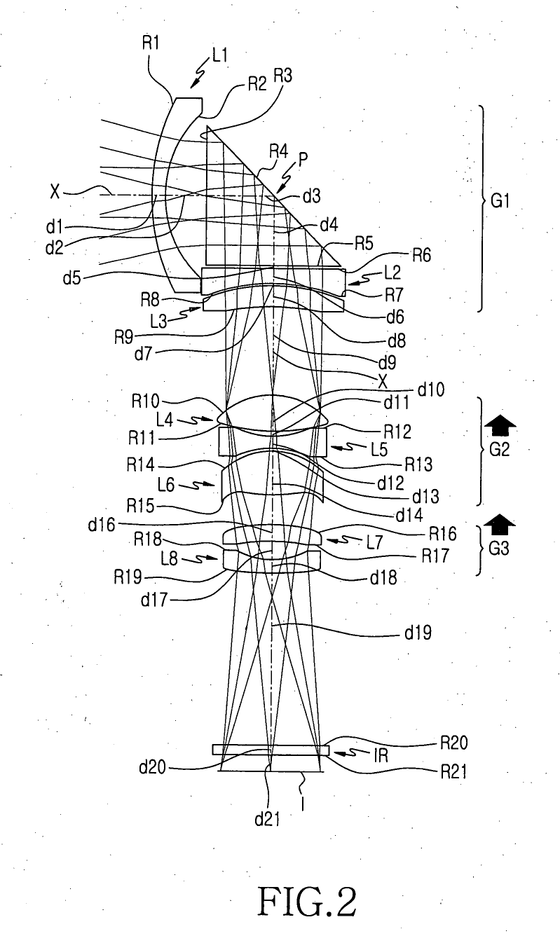

Referring to FIGS. 1 and 2, when the zoom lens system 100 zooms from the wide angle end to the intermediate end, the first lens group G1 is fixed, and the second and third lens groups G2 and G3 move toward the first lens group G1 along the optical axis X. In this case, the distance between the first and second lens groups G1 and G2 and the distance between the second and third lens groups G2 and G3 are gradually reduced.

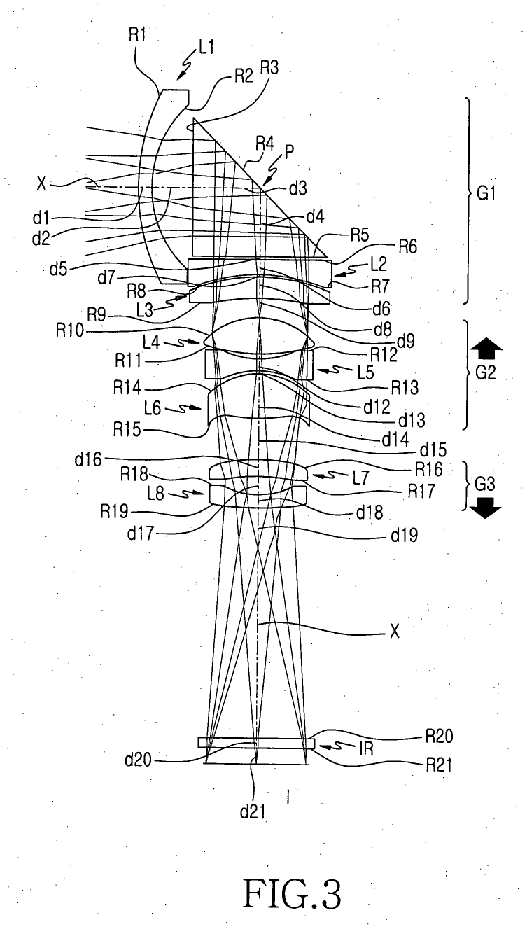

Referring to FIGS. 2 and 3, when the zoom lens system 100 zooms from the intermediate end to the telephoto end, the first lens group G1 is fixed, and the second and third lens groups G2 and G3 move toward the first lens group G1 along the optical axis X. In this case, the distance between the first and second lens groups G1 and G2 is gradually reduced, and the distance between the second and third lens groups G2 and G3 is gradually increased as the G2 is moving up while G3 is slowly moving up.

The following are simulation results showing the outcome of the improvement when practiced according to the teachings of the present invention.

Table 1 shows numerical data of components constituting the zoom lens system 100 in the wide angle end. In the numerical data, ri denotes the radius of curvature of an i^{th} optical surface Ri, di denotes the thickness of the i^{th} optical surface Ri or an air gap (or a distance) between the i^{th} optical surface Ri and an (i+1)^{th} optical surface R(i+1), ndi denotes a refractive index at the Fraunhofer d-line (587.5618 nm) of the i^{th} optical surface Ri, and vi denotes an Abbe number of the i^{th} optical surface Ri, wherein a unit of the radius of curvature and the thickness is mm. The number i is sequentially assigned from the object side to the image surface I.

In the present embodiment, when the zoom lens system 100 zooms from the wide angle end to the telephoto end, a total focal length f varies from 4.36 to 12.35, an F number varies from 2.85 to 5.66, and a view angle ω varies from 28.8° to 11°.

TABLE 1

| | | | | Abbe |
|---|---|---|---|---|
| Surface number | Radius of | | Refractive | number |
| (i) | curvature (r) | Thickness (d) | index (nd) | (v) |
| 1 | 8.12188 | 0.600000 | 1.834 | 37.1 |
| 2 | 4.12116 | 1.525000 | | |
| 3 | ∞ | 2.700000 | 1.847 | 23.8 |
| (prism) | | | | |
| 4 | ∞ | 2.700000 | 1.847 | 23.8 |
| 5 | ∞ | 0.125000 | | |
| *6 | −26.31174 | 0.500000 | 1.530 | 55.8 |
| *7 | 8.08085 | 0.115000 | | |
| 8 | 7.10404 | 0.890000 | 1.847 | 23.8 |
| 9 | 17.27074 | 6.840~3.260~0.670 | | |
| *10 | 3.04102 | 1.410000 | 1.583 | 59.3 |
| (stop) | | | | |
| *11 | −5.08438 | 0.100000 | | |
| 12 | −5.32483 | 0.500000 | 1.834 | 37.1 |
| 13 | 4.14043 | 0.100000 | | |
| *14 | 3.42699 | 1.680000 | 1.530 | 55.8 |
| *15 | −6.99530 | 2.670~1.210~1.530 | | |
| *16 | 20.54282 | 0.660000 | 1.530 | 55.8 |
| *17 | 283.77264 | 0.685000 | | |
| 18 | −3.00000 | 0.500000 | 1.517 | 64.1 |
| 19 | −15.79374 | 1.300~6.340~8.610 | | |
| 20 | ∞ | 0.400000 | 1.517 | 64.1 |
| (IR-cut filter) | | | | |
| 21 | ∞ | | | |

In Table 1, the number *i of an optical surface denotes an aspherical surface.

An aspherical surface definition formula is represented by Formula 3.

$$x = \frac{{c}^{2} {y}^{2}}{1 + \sqrt{1 - ( K + 1 ) {c}^{2} {y}^{2}}} + {Ay}^{4} + {By}^{6} + {Cy}^{8} + {Dy}^{10} + {Ey}^{12} \qquad ( 3 )$$

Here, x denotes a distance from the top of an optical surface along the optical axis X, y denotes a distance in a direction perpendicular to the optical axis X, c denotes a curvature at the top of the optical surface (a reciprocal number of the radius of curvature, K denotes a conic coefficient, and A, B, C, D, and E denote aspherical coefficients.

Aspherical coefficients of each aspherical surface in Table 1 are illustrated in Table 2.

TABLE 2

| Surface | | | | | | |
|---|---|---|---|---|---|---|
| number | K | A | B | C | D | E |
| 6 | −4.30878 | 0.34050 × 10⁻² | −0.30235 × 10⁻³ | −0.22579 × 10⁻⁴ | 0.13400 × 10⁻⁴ | −0.96084 × 10⁻⁶ |
| 7 | −1.91456 | 0.32223 × 10⁻² | −0.13272 × 10⁻³ | −0.10282 × 10⁻³ | 0.29737 × 10⁻⁴ | −0.20710 × 10⁻⁵ |
| 10 | −0.12219 | −0.26584 × 10⁻³ | 0.27657 × 10⁻³ | 0.48592 × 10⁻⁴ | −0.76279 × 10⁻⁵ | |
| 11 | −2.07370 | 0.49603 × 10⁻² | −0.57013 × 10⁻³ | −0.85840 × 10⁻⁴ | 0.78023 × 10⁻⁵ | |
| 14 | 1.12915 | 0.51068 × 10⁻² | 0.23172 × 10⁻³ | −0.40891 × 10⁻³ | 0.13124 × 10⁻³ | −0.11350 × 10⁻⁴ |
| 15 | −0.411352 | 0.11100 × 10⁻¹ | 0.16191 × 10⁻² | 0.11708 × 10⁻² | −0.41331 × 10⁻³ | 0.11655 × 10⁻³ |
| 16 | 10.00000 | 0.12225 × 10⁻¹ | 0.23008 × 10⁻² | −0.86523 × 10⁻³ | 0.46581 × 10⁻³ | −0.47235 × 10⁻⁴ |
| 17 | 0.86363 | 0.10769 × 10⁻¹ | 0.14485 × 10⁻² | 0.34140 × 10⁻³ | −0.63251 × 10⁻⁴ | 0.88268 × 10⁻⁴ |

When the zoom lens system 100 zooms in the order of the wide angle end, the intermediate end, and the telephoto end, an air gap d9 between the first and second lens groups G1 and G2 varies in the order of 6.840, 3.260, and 0.670 mm, an air gap d15 between the second and third lens groups G2 and G3 varies in the order of 2.670, 1.210, and 1.530 mm, and an air gap d19 between the third lens group G3 and the IR-cut filter IR varies in the order of 1.300, 6.340, and 8.610 mm.

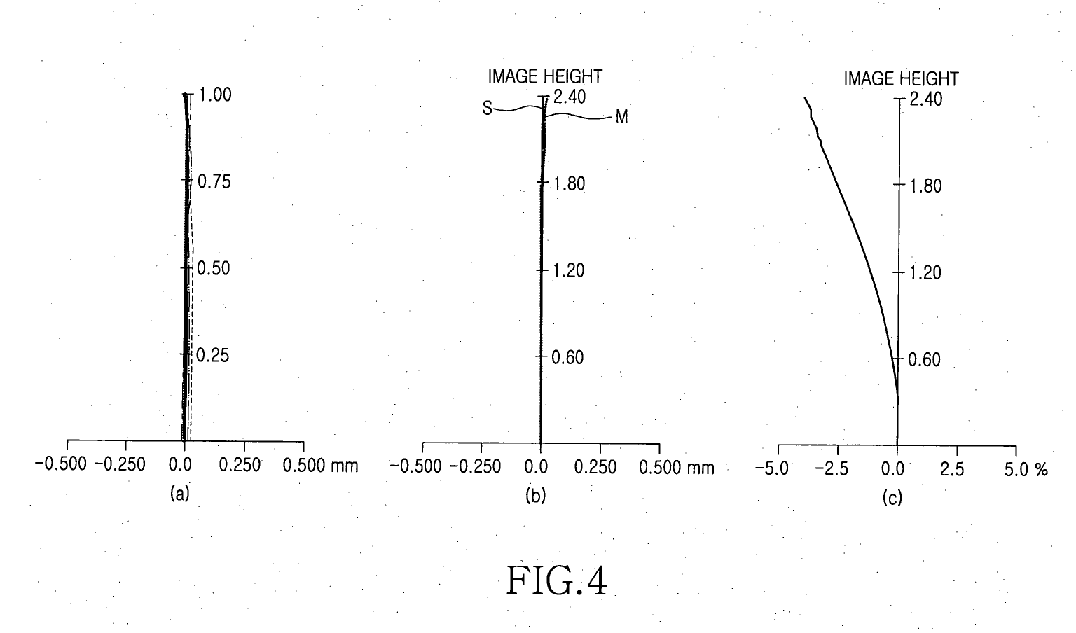

FIG. 4 illustrates aberration curves of the zoom lens system 100 in the wide angle end. FIG. 4(a) illustrates a longitudinal spherical aberration, FIG. 4(b) illustrates an astigmatic aberration, and FIG. 4(c) illustrates a distortion aberration. In FIG. 4(a), a dash-dot-dash line denotes an aberration curve with respect to a 435.8343-nm wavelength, a dotted line denotes an aberration curve with respect to a 486.1327-nm wavelength (the Fraunhofer f-line), a solid line denotes an aberration curve with respect to a 546.0740-nm wavelength, a dash-dot-dot-dash line denotes an aberration curve with respect to a 587.5617-nm wavelength (the Fraunhofer d-line), and a dash line denotes an aberration curve with respect to a 656.2725-nm wavelength.

FIG. 4(b) depicts an aberration curve M based on a meridional plane and an aberration curve S based on a sagital plane with respect to the 546.0740-nm wavelength.

FIG. 4(c) depicts an aberration curve with respect to the 546.0740-nm wavelength.

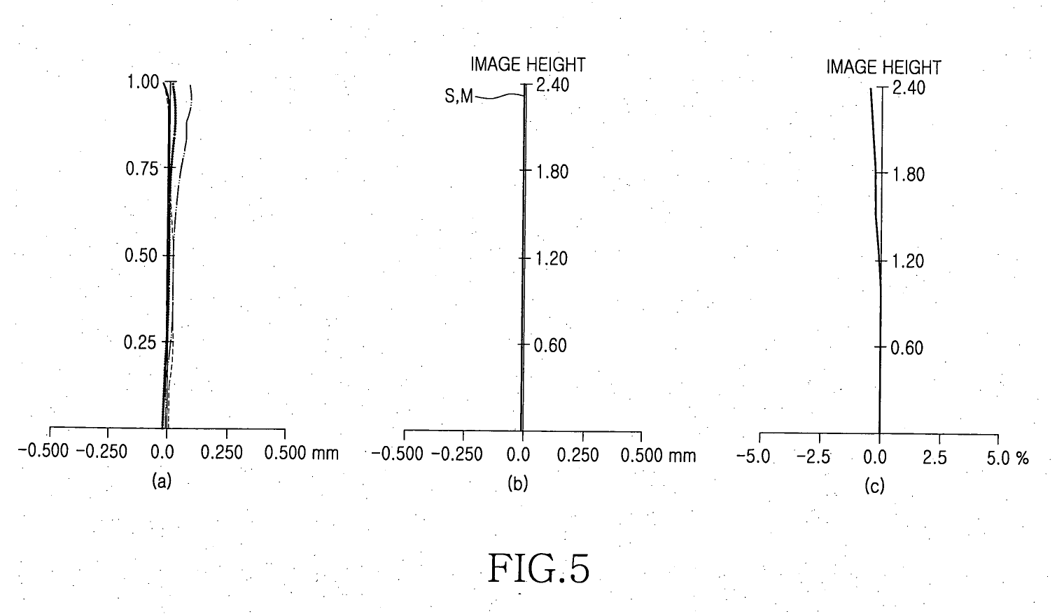

FIG. 5 illustrates aberration curves of the zoom lens system 100 in the intermediate end. FIG. 5(a) illustrates a longitudinal spherical aberration, FIG. 5(b) illustrates an astigmatic aberration, and FIG. 5(c) illustrates a distortion aberration.

In FIG. 5(a), a dash-dot-dot-dash line denotes an aberration curve with respect to the 435.8343-nm wavelength, a dotted line denotes an aberration curve with respect to the 486.1327-nm wavelength, a solid line denotes an aberration curve with respect to the 546.0740-nm wavelength, and a dash line denotes an aberration curve with respect to the 656.2725-nm wavelength. Since an aberration curve with respect to the 587.5617-nm wavelength is overlapped with other aberration curves and hardly recognized, it is not shown.

FIG. 5(b) depicts an aberration curve M based on a meridional plane and an aberration curve S based on a sagital plane with respect to the 546.0740-nm wavelength.

FIG. 5(c) depicts an aberration curve with respect to the 546.0740-nm wavelength.

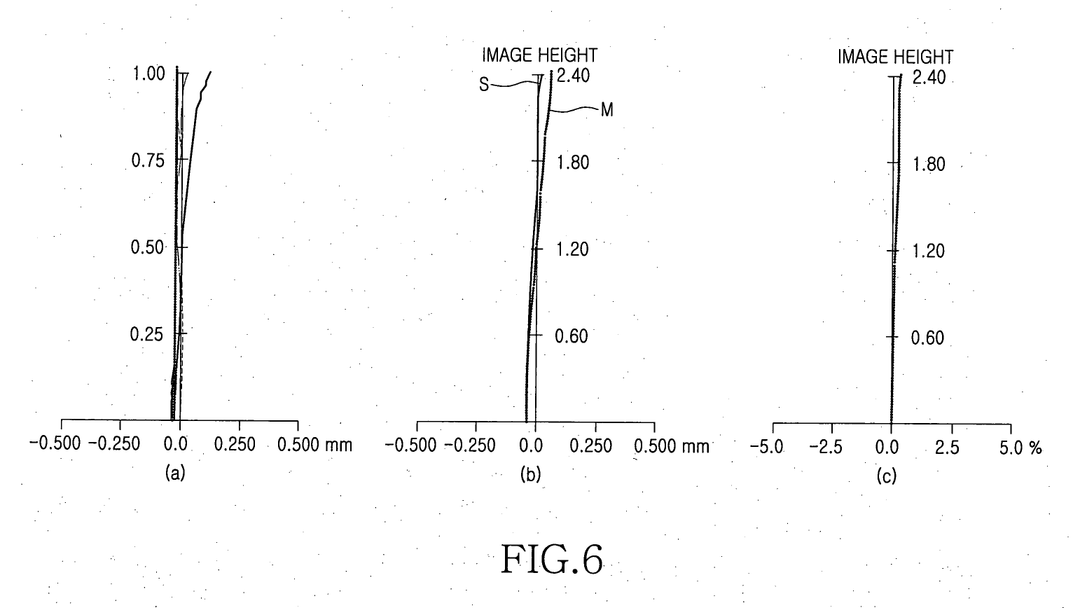

FIG. 6 illustrates aberration curves of the zoom lens system 100 in the telephoto end. FIG. 6(a) illustrates a longitudinal spherical aberration, FIG. 6(b) illustrates an astigmatic aberration, and FIG. 6(c) illustrates a distortion aberration. In FIG. 6(a), a solid line denotes an aberration curve with respect to the 435.8343-nm wavelength, a dash-dot-dash line denotes an aberration curve with respect to the 486.1327-nm wavelength, a dotted line denotes an aberration curve with respect to the 546.0740-nm wavelength, a dash-dot-dot-dash line denotes an aberration curve with respect to the 587.5617-nm wavelength, and a dash line denotes an aberration curve with respect to the 656.2725-nm wavelength.

FIG. 6(b) depicts an aberration curve M based on a meridional plane and an aberration curve S based on a sagital plane with respect to the 546.0740-nm wavelength.

FIG. 6(c) depicts an aberration curve with respect to the 546.0740-nm wavelength.

As described above, according to the present invention, a zoom lens system provides a more than 2.8:1 zoom ratio and optical performance suitable for high resolution with a miniaturized structure compared to the existing zoom lens systems.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A zoom lens system comprising:
a first lens group having a negative refracting power and disposed above an image surface;
a second lens group located closer to the image surface than the first lens group and having a positive refracting power; and
a third lens group located closer to the image surface than the second lens group and having the negative refracting power, wherein when the zoom lens system zooms from a wide angle end to a telephoto end, both a distance between the first and second lens groups and a distance between the first and third lens groups are reduced.

2. The zoom lens system of claim 1, further comprising an Infrared (IR) cut filter between the third lens group and the image surface.

3. The zoom lens system of claim 1, wherein when the zoom lens system zooms from the wide angle end to the telephoto end, the distance between the first and second lens groups is reduced, and the distance between the second and third lens groups is reduced for a predetermined time period and thereafter increased.

4. The zoom lens system of claim 1, wherein when the zoom lens system zooms from the wide angle end to the telephoto end, the first lens group is fixed.

5. The zoom lens system of claim 1, wherein the second lens group comprises a stop located at one end thereof.

6. The zoom lens system of claim 1, wherein the first lens group comprises at least two lenses having the negative refracting power, a reflective surface for bending an optical axis, and at least one lens having the positive refracting power.

7. The zoom lens system of claim 1, wherein the second lens group comprises at least two lenses having the positive refracting power and at least one lens having the negative refracting power.

8. The zoom lens system of claim 1, wherein the third lens group comprises at least one lenses having the positive refracting power and at least one lens having the negative refracting power.

9. The zoom lens system of claim 1, wherein the first lens group comprises a reflective surface for bending a light beam traveling direction along an optical axis.

10. The zoom lens system of claim 9, wherein the zoom lens system satisfies the formula below:
$$4.9 < \frac{TTL}{fw} < 6 ,$$
where TTL denotes a distance between the reflective surface and the image surface, and fw denotes a focal length of the zoom lens system in the wide angle end.

11. The zoom lens system of claim 1, wherein the zoom lens system satisfies the formula below:
$$0.7 < \frac{fw}{f 2} < 0.77 ,$$
where fw denotes a focal length of the zoom lens system in the wide angle end, and f2 denotes a focal length of the second lens group.

12. A zoom lens system comprising:
a first lens group having a negative refracting power disposed on an image surface and having a reflective surface for bending a light beam traveling direction along an optical axis;
a second lens group located closer to the image surface than the first lens group and having a positive refracting power; and
a third lens group located closer to the image surface than the second lens group and having the negative refracting power.

13. The zoom lens system of claim 12, further comprising an Infrared (IR) cut filter between the third lens group and the image surface.

14. The zoom lens system of claim 12, wherein the second lens group comprises a stop located at one end thereof.

15. The zoom lens system of claim 12, wherein when the zoom lens system zooms from a wide angle end to a telephoto end, the first lens group is fixed, a distance between the first and second lens groups is reduced, and a distance between the second and third lens groups is reduced for a predetermined time period and thereafter increased.

16. The zoom lens system of claim 12, wherein the first lens group comprises a first lens having the negative refracting power, an orthogonal prism providing the reflective surface for bending the light beam traveling direction, a second lens having the negative refracting power, and a third lens having the positive refracting power.

17. The zoom lens system of claim 12, wherein the second lens group comprises a first lens having the positive refracting power, a second lens having the negative refracting power, and a third lens having the positive refracting power.

18. The zoom lens system of claim 12, wherein the third lens group comprises a first lens having the positive refracting power, a second lens having the negative refracting power.

19. The zoom lens system of claim 12, wherein the zoom lens system satisfies the formula below:
$$4.9 < \frac{TTL}{fw} < 6 ,$$
where TTL denotes a distance between the reflective surface and the image surface, and fw denotes a focal length of the zoom lens system in the wide angle end.

20. The zoom lens system of claim 12, wherein the zoom lens system satisfies the formula below:
$$0.7 < \frac{fw}{f 2} < 0.77 ,$$
where fw denotes a focal length of the zoom lens system in the wide angle end, and f2 denotes a focal length of the second lens group.
